(19) United States
(12) Patent Application Publication
(10) Pub. No.: US 2010/0140516 A1
(43) Pub. Date: Jun. 10, 2010

(54) BOP PACKING UNITS SELECTIVELY TREATED WITH ELECTRON BEAM RADIATION AND RELATED METHODS

(76) Inventor: Stefan Butuc, The Woodlands, TX (US)

Correspondence Address: General Electric Company;GE Global Patent Operation, 2 Corporate Drive, Suite 648, Shelton, CT, 06484, US

(21) Appl. No.: 12/331,568

(22) Filed: Dec. 10, 2008

(51) Int. Cl. E21B 33/06; B29C 71/04; F16K 7/00

(52) U.S. Cl. 251/1.1; 251/1.2; 264/485; 264/477; 251/368

(57) ABSTRACT

A method of increasing the crosslink density of a seal for a blowout preventer that includes selectively applying electron beam radiation to a selected portion of a blowout preventer seal comprising a cured elastomeric material and at least one rigid insert to increase the crosslink density of the selected portion of the cured elastomeric material is disclosed. Methods of curing a seal for a blowout preventer, blowout preventers, and seals for blowout preventers are also disclosed.

### BACKGROUND OF DISCLOSURE

1. Field of the Disclosure

Embodiments disclosed herein relate generally to seals for blowout preventers used in the oil and gas industry. Specifically, the disclosed embodiments relate to locally reinforced BOP packing units and to methods of treating, curing, and manufacturing seals for use in blowout preventers.

2. Background Art

When drilling a well, the well will occasionally penetrate a layer having a formation pressure substantially higher than the pressure maintained in the well, resulting in the well to have “taken a kick.” If the pressure increase (generally produced by an influx of formation fluids) propagates to the surface, drilling fluid, well tools, and other drilling structures may, be blown out of the wellbore. Because of this risk of “blowouts,” blowout preventers are installed above the wellhead at the surface or on the sea floor to effectively seal a wellbore until active measures can be taken to control the kick. Sealing of the wellbore typically occurs by large elastomeric seal bodies referred to as “packing units.” The packing units may be activated within a blowout preventer to seal against drill pipe and well tools or be compressed upon itself (if no drill pipe or tools are present within the bore of the packing unit). Upon compression of the packing unit about a drill pipe or upon itself, the elastomeric body is squeeze radially inward, generating stress and-strain within the packing unit (particularly at areas or regions forming the sealing surfaces).

As stress is exerted on blowout preventer seals, the material of the seals will strain to accommodate the stress and provide sealing engagement. The amount of strain occurring in the material of the seal is dependent on a modulus of elasticity of the material. The modulus of elasticity is a measure of the ratio between stress and strain and may be described as a material's tendency to deform when force or pressure is applied thereto. For example, a material with a high modulus of elasticity will undergo less strain than a material with a low modulus of elasticity for any given stress.

Properties of the elastomeric material, including modulus of elasticity and elongation, depend not only on the base material (elastomer) properties, but also on the degree of curing, or degree and density of crosslinking, of the elastomeric material obtained during seal manufacture. Insufficient crosslinking results in a seal with a low modulus of elasticity and high elongation, rendering the seal susceptible to viscous flow whereas excessive crosslinking results in a seal with a high modulus of elasticity but low elongation, leading to brittle failure of the seal under stress or an inability of the seal to flex and form the desired sealing engagement. Thus, a balance exists between crosslink levels that are high enough to prevent failure by viscous flow of the seal, but low enough to avoid brittle failure.

In addition to increasing the modulus of elasticity and hardness of an elastomer seal body (and decreasing elongation) through additional crosslinking, the seal also becomes more thermally stable with increasing crosslink density. With too little crosslinking, as blowout preventer seals undergo high temperature exposure and/or heat cycling the polymer chains in the seal can re-orient themselves to a more crystalline structure and/or trigger additional crosslinking due to the chain mobility, both of which increase the brittleness of the seal. However, by providing adequate crosslinking, such phenomena are reduced due to the polymer chains being less mobile/more fixed in their location due to the presence of and amount of crosslinks between the chains.

Conventional approaches to increase the crosslink density, and thus modulus of elasticity, hardness, and thermal stability (through greater use or longer cure time of curatives), result in a uniform change in crosslink density throughout the packing unit (or other seal). Thus, when an increase in crosslink density is necessary to prevent failure by extrusion in areas such as the top inner bore or top outer surface of the seal, for example, the entire seal is subjected to greater levels of curing (through greater amounts of and/or longer exposure time to curatives). However, while this change may be desired in some areas, it may also be undesirable in other areas needing greater flexibility or that are more prone to cracking. The ability to selectively increase the crosslink density in certain desired portions of the seal, but not others, would not only allow for localized control of desired properties based on the likely failure modes for the different seal portions but would also allow for a potential reduction in cure lime of the entire seal by only curing to the lower crosslink density state.

Accordingly, there exists a need for localized control of crosslink density through an elastomeric seal to result in higher hardness, stress resistance, and extrusion resistance in selected areas of the seal under greater strain and potential for extrusion without rendering the remainder of the seal less flexible and/or more susceptible to brittle failure.

### SUMMARY OF INVENTION

In one aspect, the embodiments disclosed herein relate to a method of increasing the crosslink density of a seal for a blowout preventer that includes selectively applying electron beam radiation to a selected portion of a blowout preventer seal comprising a cured elastomeric material and at least one rigid insert to increase the crosslink density of the selected portion of the cured elastomeric material.

In another aspect, embodiments disclosed herein relate to a method of curing a seal for a blowout preventer that include molding an elastomeric material with a plurality of rigid inserts; curing the molded elastomeric material with a curative; and selectively applying electron beam radiation to a portion of the cured elastomeric material to increase the crosslink density of the portion of the cured elastomeric material.

In yet another aspect, embodiments disclosed herein relate to a seal for a blowout preventer that includes an elastomeric body; and at least one rigid insert disposed within the elastomeric body, wherein a portion of the elastomeric body has a crosslink density greater than the remaining portion of the elastomeric body.

In yet another aspect, embodiments disclosed herein relate to a blowout preventer that includes a main body having a wellbore axis defined therethrough; and a packing unit disposed within the main body and configured to seal the wellbore, wherein the packing unit includes an elastomeric body; and at least one rigid insert disposed within the elastomeric body, wherein a portion of the elastomeric body has a crosslink density greater than the remaining portion of the elastomeric body.

Other aspects and advantages of the invention will be apparent from the following description and the appended claims.

### BRIEF DESCRIPTION OF DRAWINGS

FIG. 1 shows a blowout preventer according to one embodiment of the present disclosure.

FIG. 2 depicts a graph of 100% modulus of elasticity and elongation properties varying with radiation dosage for a sulfur-cured elastomer sample.

FIG. 3 depicts a graph of 100% modulus of elasticity and elongation properties varying with radiation dosage for a peroxide-cured elastomer sample.

FIG. 4 depicts a graph of 100% modulus of elasticity and elongation properties varying with radiation dosage for a sulfur/ZnO-cured elastomer sample.

FIG. 5 depicts a graph of 100% modulus of elasticity and elongation properties varying with radiation dosage for a SWNT-filed sulfur-cured elastomer sample.

FIG. 6 depicts a graph of 100% modulus of elasticity and elongation properties varying with radiation dosage for a MWNT-filled peroxide-cured elastomer sample.

### DETAILED DESCRIPTION

Embodiments disclosed herein relate generally to seals used in blowout preventers and methods of treating, curing, and/or manufacturing seals for use in blowout preventers. More particularly, embodiments disclosed herein relate to use of electron beam radiation to increase the crosslink density of elastomeric materials of seals used in blowout preventers. More particularly still, embodiments may also particularly relate to selectively applying electron beam radiation to a blowout preventer seal in order to increase the crosslink density of the seal. Additionally, the present disclosure is directed not only to treatment of preformed seals with electron beam radiation, but also to methods of curing a seal and treating the seal with electron beam radiation.

Selective treatment (i.e., selective increase in crosslink density) of an elastomeric material may include locational selectivity as well as control of the extent (density and depth) of crosslinking. This selective control of the crosslink density of a BOP elastomeric seal permits the localized tailoring of crosslink-dependent material properties in a given region so as to increase the seal's ability to withstand loads and failure modes expected for that particular region of a seal. As mentioned above, conventional approaches to increasing crosslink density result in the entire seal being subjected to greater levels of curing. However, in accordance with embodiments of the present disclosure, use of electron beam radiation may provide control and selectivity of crosslink density in selective regions of an elastomeric seal needing greater modulus of elasticity values or other crosslink-dependent properties.

Electron beam radiation is a form of ionizing energy that may be used to form crosslinks between elastomer chains, including the elastomeric materials used in the seals of the present disclosure. In electron beam radiation, the electron beam (a concentrated, highly charged stream of electrons) is generated when a current is passed through a filament within a vacuum chamber of an “electron accelerator.” The wires heat up due to the electrical resistance and emit a cloud of electrons. These electrons are then accelerated by an electric field and move out of the vacuum chamber. Once outside the vacuum chamber, the electron beam is a powerful source of energy for breaking chemical bonds, such as in an elastomer to form radicals to trigger crosslinking between two chains.

In electron beam radiation curing, crosslinks are generated from bombarding the elastomeric seal (and the elastomer molecules in particular) with a beam of energy that is sufficiently significant to dislodge an element (e.g., a halogen element such as chlorine, fluorine) or group (e.g., mercapto group) from the polymer chain of the elastomer but sufficiently mitigated to avoid breaking or severing of the polymer backbone. After the element or group is dislodged, a free radical derivative of the original elastomer molecule exists with a free radical site on the element (usually carbon) in the polymer chain to which the dislodged element or group was previously bonded. While free radicals usually react very rapidly With other materials (indeed, free radicals are frequently referenced as very, short-term intermediary entities in kinetic models describing rapidly-executed multi-stage chemical reactions), a free radical polymer chain is relatively stable (or at least more stable) in the free radical state. The relative stability is especially true if the polymeric free radical is relatively constrained from movement and contact with other materials that would bond to the free radical site of the polymer chain. Crosslinking occurs when a first free radical site bonds with a second free radical site to yield a crosslink. In addition to covalent bond crosslinks, crosslinks may also include ionic bonds as well as those other bonds created by electronic or electrostatic attraction (for example, Van der Waal's forces). Further discussion of the use of electron beam radiation to effectuate crosslinking, and its particular application to the seals of the present disclosure, is provided in greater detail below.

The seals of the present disclosure, which are treated with electron beam radiation, may include both rigid and elastomeric materials. As used herein, a “seal” refers to a device that is capable of separating zones of high pressure from zones of low pressure. Examples of blowout preventer seals that may be used in the methods of the present disclosure include, but are not limited to, packing units, annular packing units, top seals, and variable bore rams, etc. A “rigid material,” as used herein, refers to any material that may provide structure to a seal of a blowout preventer, and may include both metal and non-metal materials. Examples of a rigid material may include, but are not limited to, steel, bronze, and high strength composites (e.g., carbon composites, epoxy composites, and thermoplastics, among others). Further, the term “elastomeric material,” as used herein, refers to polymeric materials that include thermoplastics, thermosets, rubbers, and other polymeric compounds that exhibit elastic behavior and that are commonly used for seals, o-rings, and the like.

Polylmeric materials are often defined as falling into one of three primary categories: thermoset materials (one type of plastic), thermoplastic materials (a second type of plastic), and elastomeric (or rubber-like) materials (elastomeric materials are not generally referenced as being “plastic” insofar as elastomers do not provide the property of a solid “finished” state). An important measurable consideration with respect to these three categories is the concept of a melting point—a point where a solid phase and a liquid phase of a material co-exist. In this regard, a thermoset material essentially cannot be melted after having been “set” or “cured” or “crosslinked.” Precursor component(s) to the thermoset material are usually shaped in molten (or essentially liquid) form, but once the setting process has executed, a melting point essentially does not exist for the material. A thermoplastic material, in contrast, hardens into solid form (with attendant crystal generation), retains its melting point essentially indefinitely, and re-melts (albeit in some cases with a certain amount of degradation in general polymeric quality) after having been formed. An elastomeric material does not have a melting point; rather, the elastomer has a glass transition temperature where the polymeric material demonstrates an ability to usefully flow, but without co-existence of a solid phase and a liquid phase at a melting point. Some thermosets, as well as thermoplastics, man be transformed to elastomers (or possess elastomeric properties) through crosslinking.

Elastomers may be transformed into verve robust flexible materials through vulcanization (a curing process that includes heat and curatives). In particular, during vulcanization polymer chains are crosslinked to render an elastomeric material more robust against deformation than a material made from the elastomers in their pre-vulcanized or pre-cured state. Vulcanization of the seals of the present disclosure may occur as conventionally performed in the manufacture of seals. However, in addition to such vulcanization process, the methods of the present disclosure provide for electron beam radiation treatment after the seal has been molded and subjected to curing processes.

Common types of elastomers used in forming seals for blowout preventers include nitrile-based elastomers such as nitrile-butadienes, hydrogenated nitrites, and carboxlyated nitriles. Nitrile butadiene rubbers (NBR) are unsaturated synthetic copolymers of acrylonitrile (ACN or 2-propenenitrile) and butadiene (1,2-butadiene and 1,3-butadiene). The physical and chemical properties of NBR may vary depending on the relative amounts of acrylonitrile and butadiene. For example, as the acrylonitrile content increases, the elastomer becomes more oil resistant but less flexible, and vice versa.

Hydrogenated nitrile butadiene rubbers (HNBR) are hydrogenated derivatives of NBR, often referred to as HSN or highly saturated nitrile. HNBR has similar properties as NBR, however typically with higher aging and heat resistance. As such, HNBR has good weather and abrasion resistance and mechanical strength. HNBR is often used in the oil and gas industry, when resistance to amine corrosion inhibitors and a sufficiently higher resistance to hydrogen sulfide (as compared to NBR) are desired.

Another synthetic elastomer often used in forming seals for blowout preventers is carboxylated nitrile butadiene rubber (XNBR). XNBR possesses an acidic group inserted into the polymer chain by use of a carboxylic acid-containing monomer such as an acrylic acid or methacrylic acid. The carboxylic acid group may be incorporated into the polymer chain to achieve properties such as higher crosslink density, tensile properties, continuous service temperature, chemical resistance, and hardness, as compared to NBR.

Elastomeric materials are known to exhibit a wide range of properties, from very, soft to verse hard. The property variations may be obtained by selecting a base polymer (or polymer blend) to give essential properties such as strength, aging, and environmental resistance, and then modifying hardness and modulus of elasticity properties through crosslinking the polymer chains or by using fillers to achieve the desired properties.

Conventional curatives used in curing or crosslinking elastomeric materials used in blowout preventer seals include sulfur, peroxides, metal oxides (e.g., zinc oxide), amines, and phenolic resins, with sulfur and peroxides being the most prevalent. Crosslinks are formed, for example, by forming atomic bridges of sulfur atoms (when using sulfur curatives) or carbon to carbon bonds (when using peroxides).

Fillers tropically added to elastomeric materials may be classified as reinforcing- or extending-type fillers. Reinforcing fillers may increase hardness, tensile strength, extrusion resistance, tear strength, elongation, and modulus of elasticity, examples of which include carbon black, carbon nanotubes (including single- and multi-walled nanotubes), and silica fillers. Extending fillers, such as titanium dioxide and barium sulfate, may be use to lower the cost of manufacturing without sacrificing performance properties but may also offer pigmenting properties and improve stability in oxidizing environments. The size of filler particles may range from micro-sized to nano-sized (particles smaller than a micron); however, particle size selection may depend on differences in properties of the elastomeric materials that may result. For example, use of nano-fillers may, result in a more than ten-fold increase of some properties as compared to particles larger than a micron. One example of such an increase in properties is evident when using carbon black fillers as the carbon black fillers possess high specific surface area to interact with the chains of the elastomeric materials and close particle-to-particle spacing therebetween, providing significantly improved hardness values and tensile strength in the seal.

Seals may be manufactured by conventional molding processes, accounting for changes to the radiation curing processes as described herein with respect to various embodiments. Curatives and fillers may be added to resins (polymer precursors) or to polymers prior to filling a mold cavity for molding and/or curing. It addition the present disclosure applying to homogenous seal bodies, it is also within the scope of the present invention that a single seal mat, be formed of multiple elastomeric materials, such as those described above, either as a heterogeneous, blended composition or a seal may be formed from two (or more) homogenous compositions each filling separate volumes of the seal (with gradated seams). In some embodiments, the seals may be molded and cured sequentially in a single mold cavity. In other embodiments, the seals may be molded in a mold cavity, and subsequently cured in a curing chamber (mold cavity and curing chamber may be used interchangeably herein). For example, in some embodiments, rigid materials may be disposed in a mold, and the mold may be closed and filled, as necessary, with at least one resin or molten material (i.e., molding then curing). In other embodiments, a previously molded and uncured seal may be disposed in a curing chamber (i.e., curing only). The mold or curing chamber may be heated to an elevated temperature before or after the materials are disposed in the mold.

The temperature of the materials disposed in the mold cavity may, then be increased to a temperature sufficient to cure or at least partially cure the elastomeric material. For example, heat may be supplied b) steam, oil or other fluids, or by electric heating elements. After sufficient time at the cure temperature, the cured or partially cured part is removed from the mold cavity and allowed to cool. The seal may optionally be post-cured, such as by holding the part at a post-cure temperature or slowly cooling the part, and may be used to generate desired properties. Such post-curing may be in addition to the electron beam radiation curing applied in accordance with the methods of the present disclosure.

In general, variables that may affect properties of the cured seal mat, include mold or curing chamber temperature, heating rates, cooling rates, and cure or post-cure temperatures. Typically, the temperature of the mold or curing chamber is maintained based upon the measured temperature of the heat exchange medium. Heating and cooling rates may be influenced, for example, by the type of heat exchange medium (electric, fluid, type of fluid, and the respective thermodynamic properties of the fluid), as well as the mold material (e.g., type of steel and its properties). The amount of time that the materials are at a given temperature will also affect the degree of curing. These variables (and the properties that result) may be taken into consideration When selecting a cure schedule, particularly in view of the subsequent use of electron beam radiation curing, which may be used to selectively control crosslinking. That is, in a conventional cure process, the entire elastomeric seal cures at least relatively uniformly, requiring sacrifices on the part of some desired properties for the benefit of others (e.g., modulus of elasticity vs. elongation). Thus, by providing for the ability to selectively control crosslinking through location, depth of penetration and acceleration of the electron beam focused on an elastomeric seal, select portions of the elastomeric seal may have increased levels of crosslinking, resulting in tailoring of the properties resulting from crosslinking to account for, and improve seal performance based on, the loads and failure modes expected for those portions. Improved performance may include improved sealing ability, increased number of cycles to failure. etc. Further, for embodiments in which the seal to be treated does not possess a uniform (homogenous or uniform heterogeneous blend) composition throughout the entire seal body, one or more regions (distinct in composition) may be treated with electron beam radiation. Moreover, with respect to one of such multiple regions forming the elastomeric body, each homogenous region may, in various embodiments, either be treated by electron beam radiation in a selected portion or in its entirety.

Additionally, use of electron beam radiation may also mean that “less” curing of the entire seal by conventional curing process may optionally occur, depending on the desired properties of the non-electron beam radiated regions. This may result in a cure time reduction. Alternatively, cure time (for conventional curing) may also be reduced to result in “less” curing of the entire seal, and electron beam radiation may be applied over the entire seal both to further crosslink the elastomeric material. This electron beam radiation may be applied evenly over the entire seal, or the radiation may be applied in a greater dosage or energy level to certain regions (and not to others) to result in those certain regions having a greater crosslink density as compared to the other regions.

Properties of the seal may also be affected by the type and amount of elastomeric material(s) used, the type of rigid material used, thermodynamic properties (conductivity, for example), and, if used, the type and amount of curatives or any other fillers, as well as the energy level and dosage of the electron beam treatment (affecting the amount and area of crosslink density). Seal properties may also be affected by the variations in the kinetic properties of the elastomeric material and/or curing agents.

As described above, electron beam radiation is usually sourced by an electron accelerator but may alternatively be radioactively or laser sourced. Individual accelerators are usefully characterized by their energy, power, and type. In particular embodiments of the present disclosure, an appropriate energy level may range from 50 keV to 5.0 MeV, or from 100 keV to 4.0 MeV in other embodiments. Thus, selection of an accelerator may be based on the desired energy level. For example, low-energy accelerators provide beam energies from about 150 keV to about 2.0 MeV and medium-energy accelerators provide beam energies from about 2.5 to about 8.0 MeV, whereas high-energy accelerators provide beam energies greater than about 9.0 MeV. Accelerator power is a product of electron energy and beam current. Such powers range from about 5 to about 300 kW. The main types of accelerators are: electrostatic direct-current (DC), electrodynamic DC, radiofrequency (RF) linear accelerators (LINACS), magnetic-induction LINACs, and continuous-wave (CW) machines. The amount of energy absorbed (the dose) is measured in units of kiloGrays (kGy), where 1 kGy is equal to 1,000 Joules per kilogram, or MegaRads (MR, MeRAD, or Mrad), where 1 MR is equal to 1,000,000 ergs per gram. In accordance with some embodiments of the present disclosure, dosage may range from about 50 to 2000 kGy, and from about 100 to 1000 kGy, in other embodiments.

Crosslinking may be controlled by varying two aspects of the electron beam. The depth of penetration of the beam may be controlled by the accelerating voltage, and the degree of crosslinking may be controlled by the radiation dose. Dose rate may be varied by altering the beam current, beam diameter and distance to the source. Thus, part of selective treatment of the seals, as disclosed herein, may not only include determining which locations are subject to higher failure rates, but also to determine the amount of electron beam radiation that would result in the desired crosslinking as well as desirable crosslink-dependent material properties. This determination may include both a determination of the amount of radiation dosage that will result in the desired increase of crosslink density as well as a determination of the electron energy levels that will result in a desired depth of increased crosslink density. Further, while ranges of dosage and energy levels are mentioned above, one skilled in the art would appreciate that the accelerating voltage, dosage, etc., may be varied from those ranges mentioned above depending on the desired crosslinking.

Thus, in accordance with embodiments of the present disclosure, electron beam radiation may be used in conjunction With conventional cure processes or to treat a selected portion of conventionally cured seals (previously formed), to remedy problems or deficiencies associated with the conventional cure techniques. Specifically, electron beam radiation-curing may enhance the performance of a conventionally cured material by selectively increasing the number of crosslinks in a particular portion or portions of the seal to impart greater strength and extrusion resistance to that (those) portion(s) susceptible to extrusion while under pressure.

For example, an annular blowout preventer packing unit may be treated with electron beam radiation in selected portions such as the top inner bore or top outer surface, bottom outer surface, or any other areas that may benefit from having greater crosslink density, and thus may have greater modulus of elasticity and extrusion resistance, as compared to the remaining portions of the packing unit. However, the methods disclosed herein are not limited to treatment of packing units for annular blowout preventers. Rather, these methods may equally apply to any seal, including ram packers, top seals of a unit, lateral seals, variable bore rams, etc.

Further, because the degree and depth of crosslinking may be readily controlled by varying the electron beam characteristics, as described above, particular material or mechanical properties desired may be controllably achieved. One skilled in the art would appreciate that the desired properties may be determined based upon the amount of pressure, stress, operational conditions, etc. to which an elastomer seal may be exposed during the seal's operational use.

Thus, in one illustrative embodiment, the crosslink density of a seal for a blowout preventer may be increased by selectively applying electron beam radiation to a portion of a blowout preventer seal comprising a cured elastomeric material and a plurality of rigid inserts to increase the crosslink density of the selected portion of the cured elastomeric material. The portion of the seal selected for application of electron beam radiation may be a localized portion of the seal susceptible to extrusion. Thus, prior to selectively applying the electron beam radiation, an analysis of the seal may be performed so that the portion of the blowout preventer seal susceptible to extrusion may be determined such that the portion susceptible to extrusion is the portion selectively treated with electron beam radiation. This analysis may also include a determination of the amount of electron beam radiation to effectuate the desired increased crosslink density and corresponding changes in the seal's material properties. Determination of the amount of electron beam radiation to be applied may include determination of the electron beam radiation dosage and/or electron beam energy level.

In another illustrative embodiment, the present disclosure also relates to methods of curing a seal for a blowout preventer. Such methods may include molding an elastomeric material with a plurality of rigid inserts; curing the molded elastomeric material with a curative; and selectively applying electron beam radiation to a portion of the cured elastomeric material to increase the crosslink density of the portion of the cured elastomeric material. Similar to embodiments described above, the portion of the seal selected for application of electron beam radiation may be a localized portion of the seal susceptible to extrusion. Thus, prior to selectively applying the electron beam radiation, an analysis of the seal may be performed so that the portion of the blowout preventer seal susceptible to extrusion may be determined such that the portion susceptible to extrusion is the portion selectively treated with electron beam radiation. This analysis may also include a determination of the amount of electron beam radiation to effectuate the desired increased crosslink density and corresponding changes in the seal's material properties. Determination of the amount of electron beam radiation to be applied may include determination of the electron beam radiation dosage and/or electron beam energy level.

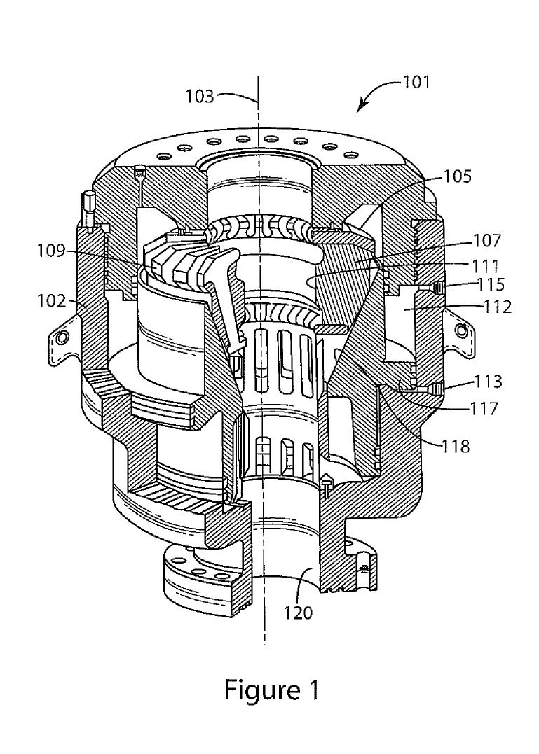

Referring to FIG. 1, an annular blowout preventer 101 that may include a packing unit in accordance with the embodiments disclosed herein is shown. Annular blowout preventer 101 includes a housing 102 having a central bore 120 extending therethrough along a borehole axis 103. A packing unit 105 is disposed within annular blowout preventer 101 about central bore 120 such that a bore 111 of the packing unit 105 is substantially concentric with bore 120 of blowout preventer 101.

As depicted in FIG. 1, packing unit 105 includes an elastomeric annular body 107 and a plurality of metal inserts 109. Metal inserts 109 are shown disposed within elastomeric annular body 107 of packing unit 105 in radial planes in a generally circular fashion about borehole axis 103 (the longitudinal axis (not shown) of packing unit 105 is aligned with borehole axis 103). In use, hydraulic fluid may enter a cylinder 112 through an activation port 113, thereby thrusting an actuation piston 117 in an upward direction. As piston 117 is thrust upward, an inclined surface 118 of actuation piston 117 compresses packing unit 105 so that bore 111 is reduced as metal inserts 109 are displaced toward borehole axis 103. To open bore 111, hydraulic fluid is diverted to a retraction port 115 and piston 117 is urged in a downward direction.

In accordance with embodiments disclosed herein, a selected portion packing unit 105 shown in FIG. 1, and a selected portion of elastomeric annular body 107, specifically, may be subjected electron beam radiation to increase the crosslink density, of the selected portion. As described above, such selected portions may be those subject to extrusion, for example, through the large “gap” in the annular space between inclined surface 118 and bore 120. Such portions needing an increased crosslink density may be determined based on previous visual inspection of worn packing units and/or proactively through Finite Element Analysis (FEA) analysis to simulate and evaluate the stress and/or strain concentrations that occur across the seal under given displacement conditions (forces, load states, strains) as well as the portions of the seal which may be susceptible to extrusion. Use of FEA analysis in designing seals for blowout preventers is described in U.S. Patent Publication No. 2008/0027693, which is assigned to the present assignee and herein incorporated by reference in its entirety. Thus, the present disclosure is not limited to the particular region or particular type of blowout preventer seal that is treated with electron beam radiation.

### EXAMPLES

The following examples are provided to further illustrate the application and the use of electron beam radiation to further cure pre-cured (by conventional curing means) elastomer specimens (6 inches×6 inches×6 inches in size). The specimen samples include: a sulfur-cured NBR (Samples 1 and 6); a peroxide-cured HNBR (Samples 2 and 7); a sulfur/zinc oxide-cured XNBR (Samples 3 and 8); single wall nanotube (SWNT)-filled sulfur-cured NBR (Samples 4 and 9); and SWNT-filled peroxide-cured HNBR (Samples 5 and 10). The sulfur-cured NBR samples were pre-cured for 15 min at 320° F.; the peroxide-cured HNBR samples were pre-cured for 45 min at 320° F.; and the sulfur/ZnO-cured XNBR samples were pre-cured at 15 min at 320° F. The SWNT-filled sulfur-cured NBR samples were pre-cured for 15 min at 300° F., with SWNT loading of 2.82%. The SWNT-flilled peroNide-cured HNBR samples were pre-cured for 30 min at 320° F. with SWNT loading of 6.39%. Each sample was molded in the heat press to 6″×6″ slabs, with the indicated cure time/temp. Dumbbell specimens (or dogbone) were cut from the slabs. Electron beam radiation was applied on these dumbbell specimens uniformly edge to edge.

Referring now to Table 1, a radiation curing schedule listing radiation dosages and radiation energy for Samples 1-5 is shown. As shown in Table 1, specimen Samples 1-5 were exposed to a range of radiation dosages from 150 to 750 kGy at a fixed 3000 keV of radiation energy.

TABLE 1

| | | Radiation Dosage | Radiation Energy |
|---|---|---|---|
| Sample No. | Sample Type | (kGy) | (keV) |
| 1 | Sulfur-Cured NBR | 150 | 3000 |
| | | 300 | |
| | | 450 | |
| | | 750 | |
| 2 | Peroxide-Cured | 150 | 3000 |
| | HNBR | 300 | |
| | | 450 | |
| | | 750 | |
| 3 | Sulfur/ZnO-Cured | 150 | 3000 |
| | XNBR | 300 | |
| | | 450 | |
| | | 750 | |
| 4 | SWNT-filled NBR | 150 | 3000 |
| | | 750 | |
| 5 | SWNT-filled | 150 | 3000 |
| | HNBR | 750 | |

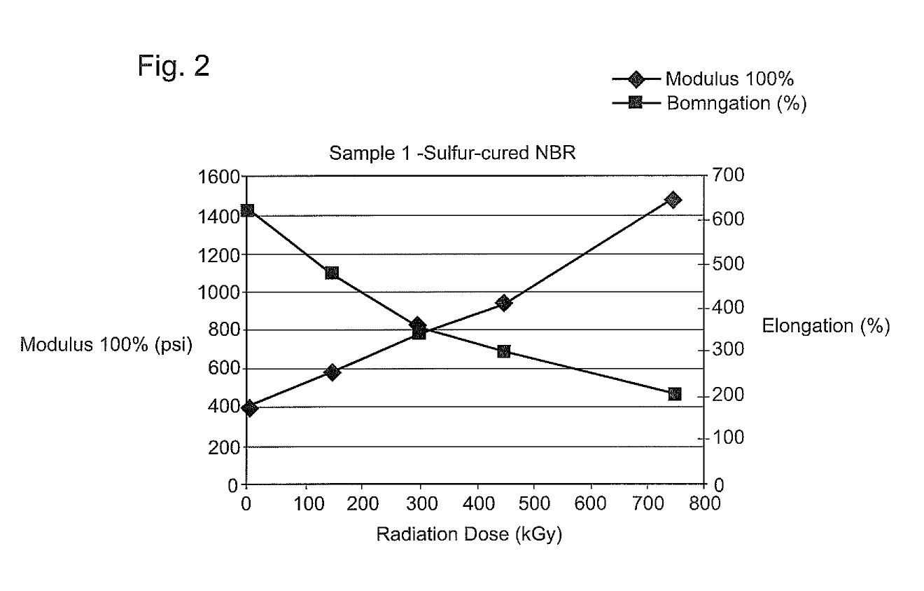

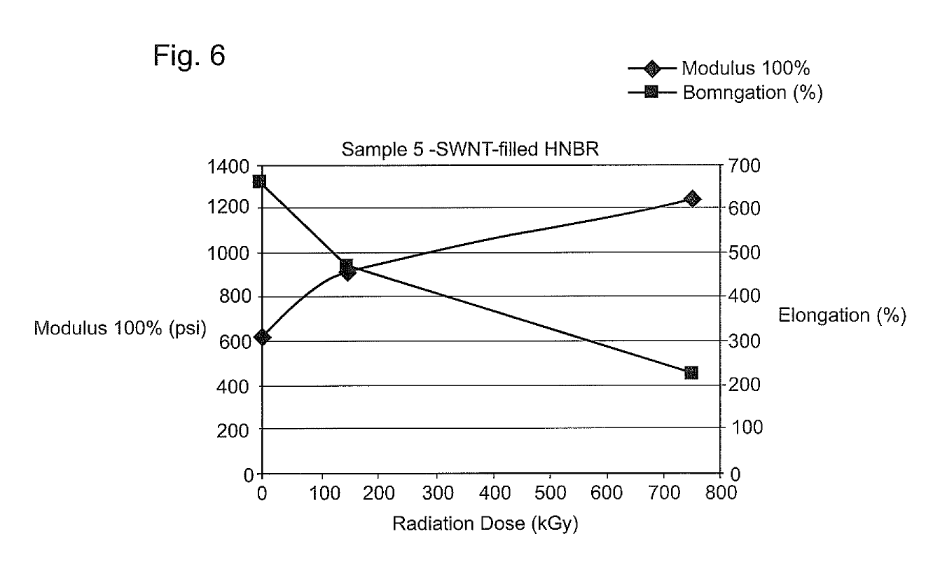

Modulus of elasticity and elongation are evaluated for each sample to examine the effect of the radiation dosage listed in Table 1 on the two properties of the cured samples. Modulus of elasticity refers to the stiffness of a material and is a measurement of the amount of force needed to deform a material a set amount. Thus, 100% modulus of elasticity is a measurement of the amount of force needed to deform a material by 100%, i.e., double the length. Elongation (also referred to as elongation at break) is a measurement of the increase in length of a material produced by stretching the material to its breaking point, expressed as a percentage of the initial length of the material. Referring now to FIGS. 2-6, plots of the resulting 100% modulus of elasticity and elongation for Samples 1-5 at the radiation curing schedules detailed in Table 1 are shown.

The effects of electron beam radiation curing of Sample 1, a sulfur-cured nitrile-butadiene rubber (NBR) sample, are shown in FIG. 1. The electron beam curing results in the 100% modulus of elasticity increasing from 400 to 1500 psi as the radiation dosage increases, indicating that the modulus of elasticity (hardness) of the elastomer increases as the radiation dose increases. For example, as shown in FIG. 1, upon Sample 1 absorbing 150 kGy of radiation energy, the 100% modulus of elasticitv increases from 400 psi to 590 psi, indicating that the compound now requires 590 psi of pressure to stretch the material to twice its original dimension. The 100% modulus of elasticity shows an almost linear increase as the crosslink density increases (absorbed radiation energy), whereas the elongation decreases with increased radiation dose (and increased crosslink density). The elongation at break of Sample 1 decreases from slightly greater than 600% to slightly greater than 200% across the range of absorbed radiation dose. For example, upon Sample 1 absorbing 450 kGy of radiation energy, Sample 1's elongation decreases from ˜615% to ˜340%, such that the elastomer can only experience a stretch of ˜340% of its original length before being pulled apart. Thus. it is clear that increasing crosslink density, requires balancing of desired properties, including, but not limited to modulus of elasticity, and elongation. For example, while an increased modulus of elasticity may provide a seal with ability to withstand greater amounts of stress, the seal mart also be more likely to break at shorter elongations. Thus, a balance of acceptable ranges of modulus of elasticity and elongation (as well as other desirable properties) may be determined, and a dosage that results in such properties deemed to be acceptable may be determined.

The effects of electron beam radiation curing of Sample 2, a peroxide-cured hydrogenated nitrile-butadiene rubber (HNBR), are shown in FIG. 2. As discussed above, peroxide-cured HNBR is a hydrogenated/saturated-derivative of NBR, generally considered to have greater temperature resistance and mechanical strength over the standard NBR material. As shows in FIG. 2, as radiation dosage of Sample 2 increases, the modulus of elasticity increases from about 500 to about 2100 psi (at a slightly more linear relationship than Sample 1 (NBR)), and elongation decreases from 325% to 100%, indicating that the elastomer becomes tougher as the radiation dose increases.

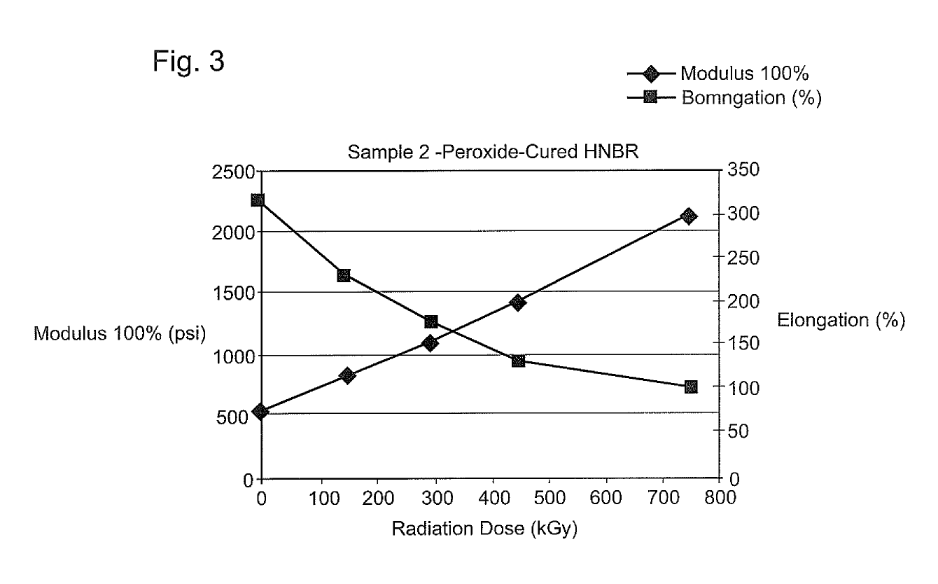

The effects of electron beam radiation curing of Sample 3, a sulfur/ZnO-cured carboxylated nitrile-butadiene rubber (XNBR), are shown in FIG. 3. As discussed above, XNBR is a carboxylated derivative of NBR by having a carboxylic acid-containing monomer copolymerized with ACN and butadiene. As shown in FIG. 3, as radiation dosage of Sample 3 increases, the 100% modulus of elasticity increases from about 1500 to about 3750 psi while the elongation decreases from about 320% to about 75%.

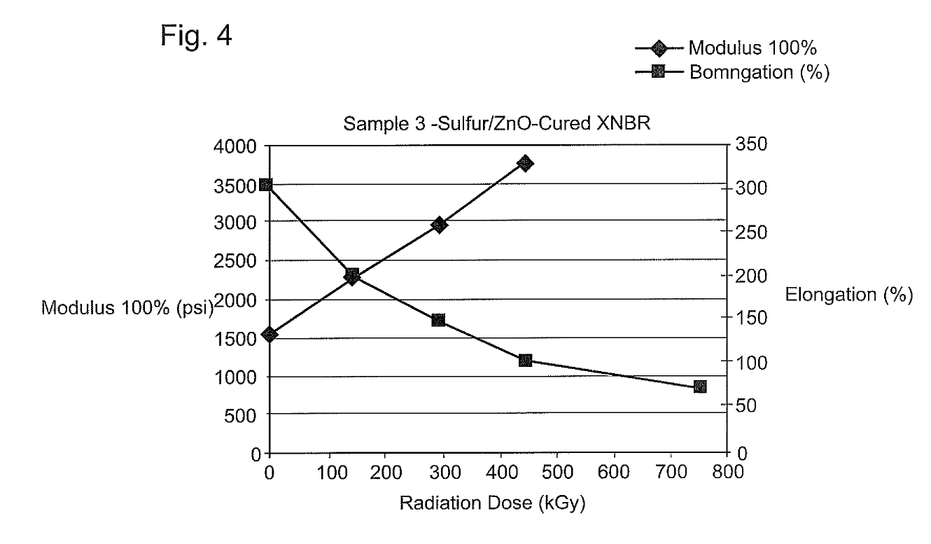

The effects of electron beam radiation curing of Sample 4, a SWNT-filled NBR sample, are shown in FIG. 4. As shown in FIG. 4, as radiation dosage of sample 4 increases, the 100% modulus of elasticity may range from about 550 to about 2200 psi, and the elongation may, decrease from about 525% to about 80%. As compared to Sample 1 (without SWNT fillers), the modulus of elasticity of the SWNT-filled NBR sample, prior to applying any radiation energy, is greater than that NBR sample without filler, which is expected due to the presence of reinforcing fillers. In addition to the initial difference in modulus of elasticity values, the application of electron radiation results in a shift of the intersection of the modulus of elasticity and elongation curves. That is, for a given range of modulus of elasticity and elongation values determined to be acceptable, incorporation of a nanofiller into the elastomer may allow for a lower dosage of electron radiation to produce the same “acceptable” modulus of elasticity and elongation ranges as a radiation cured elastomer without nanofillers, thus reducing processing time and associated costs.

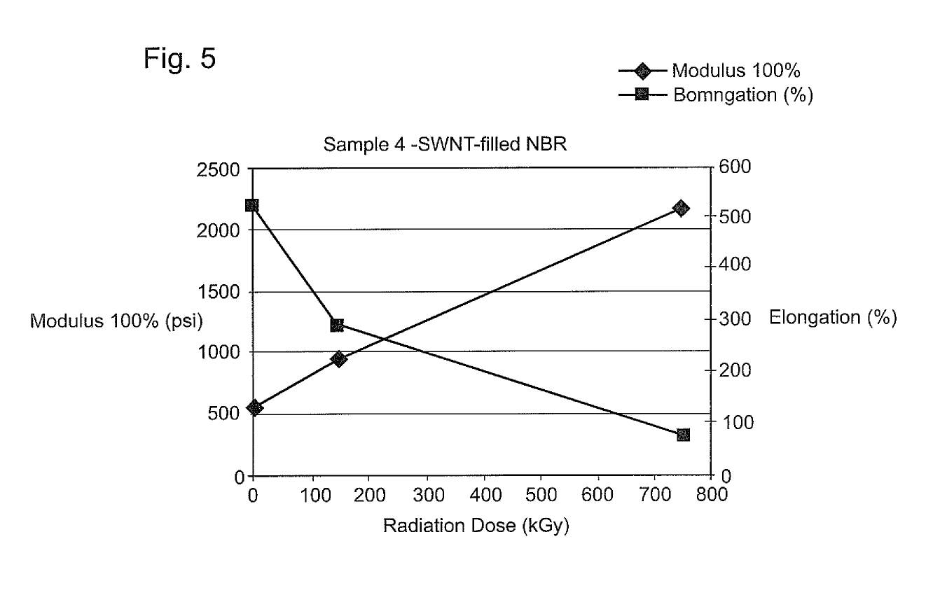

The effects of electron beam radiation curing of Sample 5, a SWNT-filled HNBR sample, are shown in FIG. 5. As shown in FIG. 5, as radiation dosage of Sample 5 increases, the 100% modulus of elasticity ranges from about 600 to about 1215 psi, and the elongation decreases from about 650% to about 225. Similar to the comparison between Samples 1 and 4. Sample 5 may be compared to Sample 2 (HNBR without SWNT fillers). The comparison between FIGS. 2 and 5 also shows that the application of electron radiation results in a shift of the intersection of the modulus of elasticity and elongation curies, and that incorporation of a nanofiller into the elastomer may allow for a lower dosage of electron radiation to produce the same “acceptable” modulus of elasticity and elongation ranges as a radiation-cured elastomer without nanofillers. Thus, among other known benefits that nanofillers mats provide nanofillers may allow for less electron beam radiation to be applied to achieve a similar result as a radiation-cured elastomer without nanofillers.

Samples 6-10 were also subjected to electron beam radiation curing at varying radiation energy levels. Upon exposure to the various levels of electron energy, the hardness was measured on the exposed and opposite faces of the specimens using the Shore A scale, as shown in Table 2 below. As shown in Table 2, each sample generally exhibits increased (or the same) hardness values upon curing with radiation. Additionally, as the radiation energy, is increased, the depth of penetration of the electron beam curing also increases, as evidenced by the effected hardness of the opposite face of sample.

TABLE 2

| | | | Radiation | Hardness | Hardness |
|---|---|---|---|---|---|
| | | Radiation | Dosage | Exposed Face | Opposite Face |
| Sample No. | Sample Type | Energy (keV) | (kGy) | (Shore A) | (Shore A) |
| 6 | Sulfur-Cured | 0 | | 78 | 78 |
| | NBR | 1000 | | 83 | 78 |
| | | 2000 | | 83 | 80 |
| | | 3000 | | 83 | 80 |
| 7 | Peroxide-Cured | 0 | | 77 | 77 |
| | HNBR | 1000 | | 80 | 77 |
| | | 2000 | | 80 | 77 |
| | | 3000 | | 80 | 77 |
| 8 | Sulfur/ZnO- | 0 | | 88 | 88 |
| | Cured XNBR | 1000 | | 90 | 88 |
| | | 2000 | | 90 | 90 |
| | | 3000 | | 91 | 90 |
| 9 | SWNT-filled | 0 | | 77 | 77 |
| | NBR | 1000 | | 80 | 77 |
| | | 3000 | | 80 | 80 |
| 10 | SWNT-filled | 0 | | 77 | 77 |
| | HNBR | 1000 | | 86 | 80 |
| | | 3000 | | 90 | 83 |

Embodiments disclosed herein may provide for at least one of the following advantages. While conventional curing methods only offer uniform curing throughout an entire seal, the treatment methods of the present disclosure may allow for selective treatment of regions of the seal for which greater crosslink density (and thus greater modulus of elasticity) is desired. Use of electron beam radiation may be used to selectively treat regions of the seal for which localized changes in properties are desired. Thus, methods of the present disclosure may provide methods for obtaining blowout preventer seals having areas with increased crosslink density for better strength under pressure and at elevated temperatures. Additionally, electron beam radiation may be used to cure a partially-cured seal that, upon treatment with electron beam radiation, achieves full strength while reducing the amount of press cure time.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

What is claimed:

1. A method of increasing the crosslink density of a seal for a blowout preventer, the method comprising:
selectively applying electron beam radiation to a selected portion of a blowout preventer seal comprising a cured elastomeric material and at least one rigid insert to increase the crosslink density of the selected portion of the cured elastomeric material.

2. The method of claim 1, wherein the selected portion is susceptible to extrusion.

3. The method of claim 1, further comprising:
prior to the selectively applying, determining a portion of the blowout preventer seal susceptible to extrusion, wherein the selectively applying comprises selectively applying electron beam radiation to the determined portion.

4. The method of claim 1, further comprising:
determining an electron beam radiation treatment required for a desired increase of crosslink density to a given depth of the blowout preventer seal.

5. The method of claim 4, wherein determining the electron beam radiation treatment comprises determining a radiation dosage to achieve the desired increase in crosslink density.

6. The method of claim 5, wherein the radiation dosage ranges from about 50 to about 2000 kGy.

7. The method of claim 4, wherein the determining the given depth comprises determining an electron beam energy level required for the electron beam radiation to penetrate to the given depth.

8. The method of claim 7, wherein the electron beam energy level ranges from about 50 keV to about 5000 keV.

9. A method of curing a seal for a blowout preventer, the method comprising:
molding an elastomeric material With a plurality of rigid inserts;
curing the molded elastomeric material with a curative; and
selectively applying electron beam radiation to a portion of the cured elastomeric material to increase the crosslink density of the portion of the cured elastomeric material.

10. The method of claim 9, wherein the curative comprises at least one of sulfur, peroxides, metal oxides, amines, or phenolic resins.

11. The method of claim 9, wherein the selected portion is susceptible to extrusion.

12. The method of claim 9, further comprising: prior to the selectively applying, determining a portion of the blowout preventer seal susceptible to extrusion wherein the selectively applying comprises selectively applying electron beam radiation to the determined portion.

13. The method of claim 9, further comprising:
determining an electron beam radiation treatment required for a desired increase of crosslink density to a given depth of the blowout preventer seal.

14. A seal for a blowout preventer, comprising:
an elastomeric body; and
at least one rigid insert disposed within the elastomeric body,
wherein a portion of the elastomeric body has a crosslink density greater than the remaining portion of the elastomeric body.

15. The seal of claim 14, wherein the elastomeric body comprises at least one nitrile-based elastomer selected from a nitrile-butadiene, a hydrogenated nitrile, and a carboxlyated nitrile.

16. The seal of claim 14, wherein the elastomeric body has as least one filler contained therein.

17. The seal of claim 14, wherein the greater crosslink density is achieved by electron beam radiation.

18. A blowout preventer, comprising:
a main body having a wellbore axis defined therethrough; and
a packing unit disposed within the main body and configured to seal the wellbore, wherein the packing unit comprises an elastomeric body and at least one rigid insert disposed within the elastomeric body, a portion of the elastomeric body having a crosslink density greater than the remaining portion of the elastomeric body.

19. The blowout preventer of claim 18 wherein the elastomeric body comprises at least one nitrile-based elastomer selected from the group consisting of a nitrile-butadiene, a hydrogenated nitrile, and a carboxlyated nitrile.

20. The blowout preventer of claim 18, wherein the greater crosslink density is achieved by electron beam radiation.
